(19) United States
(12) Patent Application Publication
(10) Pub. No.: US 2009/0207249 A1
(43) Pub. Date: Aug. 20, 2009

(54) CLIMATE CONTROLLED SURVEILLANCE SYSTEM

(76) Inventors: Bulent Erel, Roswell, GA (US); Cheng Jia, Augusta, GA (US); Chris W. Harden, Griffn, GA (US); Raymond V. Pagano, Stone Mountain, GA (US); James L. Pfaffenberger, Marietta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/371,312

(22) Filed: Feb. 13, 2009

Related U.S. Application Data
(60) Provisional application No. 61/028,598, filed on Feb. 14, 2008.

(51) Int. Cl. H04N 5/00

(52) U.S. Cl. 348/143; 348/E05.001

(57) ABSTRACT

A climate controlled surveillance system that includes a housing for enclosing a surveillance device. The system includes a Peltier device and a liquid coolant. The Peltier device extracts heat from the housing, which is then transferred to the liquid coolant by conduction and/or convection.

### CROSS-REFERENCE TO RELATED APPLICATIONS

This application claims the benefit of U.S. Provisional Patent Application Ser. No. 61/028,598, filed Feb. 14, 2008; which application is incorporated herein by reference in its entirety for all purposes.

### TECHNICAL FIELD

The present invention relates generally to surveillance systems, and more particularly, to climate controlled surveillance camera housings having a Peltier driven heat pump.

### BACKGROUND OF THE INVENTION

Typically, the electrical components of surveillance systems produce large amounts of heat during operation. For surveillance systems contained within a housing or case, it is difficult to remove the heat generated by the system electronics. However, this heat must be removed from the system in order to keep these components within their safe operating temperatures and to prevent overheating. Generally, overheated components and parts have a shorter life-span than those components that are kept within optimal temperature ranges (i.e. components are damaged by excess heat). Additionally, electrical components of surveillance systems do not function properly and/or efficiently when they are overheated.

Several methods for removing heat from surveillance systems are presently known, such as air cooling, heat sink cooling, and liquid cooling. Usually, surveillance systems utilize air cooling (fans) to remove heat from the systems. However, as surveillance technology advances, surveillance systems become more complex and additional heat generating electrical components are added. Such components tax the heat removing capabilities of known surveillance systems. To adequately cool these additional components, known surveillance systems often add additional fans. However, the addition of numerous fans increases the size of the surveillance systems, increases the noise emanating from the system, and increases the overall maintenance load. Moreover, the fans themselves create heat within the systems. Also, in many instances it is desirable to seal a camera housing to prevent external dust, moisture or contaminates from entering the housing, which makes the use of fans undesirable.

Thermoelectric cooling, which uses the Peltier effect to create a heat flux between two different types of materials, has recently been considered as a cooling method to remove heat from electrical systems that are not conducive to having fans or other methods of cooling. A Peltier cooler transfers heat from one side of the device to the other side against a temperature gradient (i.e. transfers heat from cold to hot) as electricity is applied to the device. Typically, the device is connected to a DC voltage source, which causes one side of the device to cool, while the other side is warmed. The amount of heat that is transferred from the cool side to the warm side depends on the amount of electricity that is applied to the device, coupled with how quickly the heat on the warm side is removed from the device. However, surveillance systems that have attempted to employ thermoelectric coolers, or Peltier devices, have not been able to successfully extract heat from the system.

Thus it can be seen that needs exist for improvements to climate controlled surveillance system housing. It is to the provision of an improved housing system meeting this and other needs that the present invention is primarily directed.

### SUMMARY OF THE INVENTION

In example forms, the present invention is a climate controlled housing for a surveillance system. The surveillance system can include any type of surveillance device including a video camera, still camera, listening device, and/or an illuminator. In operation, the surveillance system typically generates heat that can damage electrical components. Therefore the present invention includes a cooling system to remove the heat generated therein to an external environment. Advantageously, the overall surveillance cooling system includes a Peltier device that is coupled with a liquid cooling system to significantly increase the cooling efficiency of a standard Peltier device.

In one aspect, the present invention relates to a climate controlled surveillance system that includes a housing for enclosing a surveillance device. The surveillance device generates heat during operation. The surveillance system includes a heat pump for cooling the housing. The heat pump includes a Peltier device and a liquid cooling block. The Peltier device extracts heat from the housing, which is then absorbed by the liquid cooling block. Optionally, the surveillance system further comprises a liquid pump for circulating a cooling liquid through the liquid cooling block to remove heat from the block. The cooling liquid can then be circulated through a heat exchanger to eject heat into an environment external to the surveillance system. The surveillance device can include surveillance equipment such as, but not limited to, a video camera, a still camera, an illuminator, and/or a listening device.

In another aspect, the present invention relates to a cooling apparatus for a surveillance system that includes a Peltier driven heat pump, a heat exchanger, a liquid reservoir, and at least one liquid pump for pumping a liquid coolant through one or more tubes. The tubes are in connection with the heat pump, heat exchanger, and the liquid reservoir. Optionally, the heat pump includes at least one fan, a heat sink, a Peltier device, and a liquid cooling block. Still optionally, the heat pump includes a water collection pan.

In still another aspect, the present invention relates to an improvement to a surveillance system having a housing and at least one surveillance device, the device being at least partially contained within the housing. The improvement includes a cooling system for removing heat from the housing. The cooling system has a Peltier device in communication with a liquid coolant and at least one fan. The fan is substantially contained within the housing for circulating air therein.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a side view, in partial cutaway, of a surveillance system according to an example embodiment of the present invention.

FIG. 2 is an exploded perspective view of a heat pump used within the surveillance system of FIG. 1.

FIG. 3 is a schematic of the cooling system of the surveillance system of FIG. 1.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

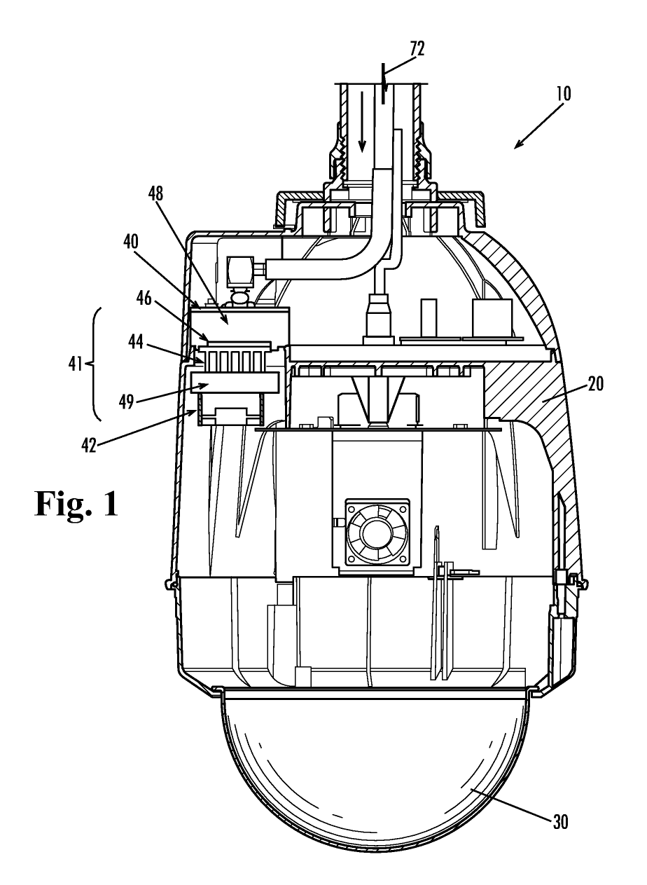

With reference now to the drawing figures, FIG. 1 shows a surveillance system 10 according to example embodiments of the present invention. The surveillance system 10 can be a pole mounted system, wall mounted system, or any other type of surveillance system. The surveillance system 10 of the present invention generally includes a housing 20 comprising a transparent dome section 30, at least one surveillance device fully or partially enclosed within the housing, and a cooling system 40. The surveillance device, in conjunction with related components/circuitry, generates heat within the housing as it operates, and/or sunlight or ambient surroundings can cause a buildup of heat within the housing. If excessive heat builds up within the housing 20, the temperature of the equipment rises and the surveillance device can be damaged and/or malfunction as a result.

The cooling system 40 transfers heat from within the housing 20 to the surrounding environment. By removing heat from within the housing 20, the cooling system 40 maintains temperatures within an optimal/acceptable range of operating temperatures for the components therein. The optimal operating temperature that is desired will vary depending on the type of surveillance device present within a particular surveillance system 10, but in example embodiments it is desired that the ambient internal temperature be less than 90° F., and more preferably under 80° F. In example embodiments, the surveillance device may be a video camera, still camera, listening device, illuminator, or any other conventional or unconventional surveillance tool.

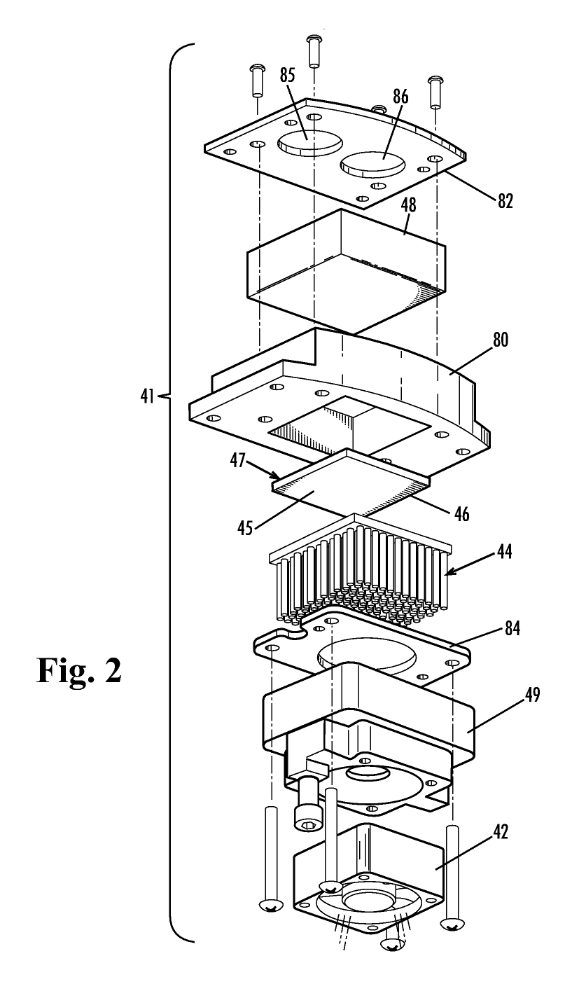

In the example embodiment depicted in FIGS. 1-3, the cooling system 40 comprises a heat pump 41 (as better seen in FIG. 2), a heat exchanger 50, a liquid reservoir 60, and a liquid pump 70. These components of the cooling system 40 are linked together by one or more tubes 72 for carrying a liquid therein. In example embodiments of the present invention, the heat pump 41 is the only component of the cooling system 40 that is located within the housing 20 (as seen in FIG. 1), however, in alternative embodiments, other components can be located within the housing as desired. The heat pump 41 further comprises at least one fan 42, a heat sink 44, a Peltier device 46, and a liquid cooling block 48. Although only one fan 42 is shown in the drawing figures, two or more fans can be used in alternative embodiments as desired. The arrangement of components of the heat pump 41 can better be seen in FIG. 2.

As depicted in FIG. 2, in example embodiments the individual elements of the heat pump 41 are secured together within a rigid frame having a frame body 80 that is encapsulated by an upper frame member 82 and a lower frame member 84. In preferred embodiments, the frame is constructed of rigid plastic. Alternatively, the frame can be constructed from rubber, aluminum, steel, other metals, polymers, and/or wood. The frame body 80 is adapted to receive the liquid block 48 and the Peltier device 46 therein. Within the frame body 80, the liquid block 48 is adjacent the top of the Peltier device. While not required, it is preferred that the Peltier device 46 and liquid block 48 be in physical contact with each other to better facilitate heat transfer. The upper frame member 82 is secured to the top of the frame body 80, and includes at least one cutout, and preferably two cutouts 85, 86 therethrough to permit liquid tube 72 access to the liquid block 48. The heat sink 44 is coupled to the base of the Peltier device 46 and is secured to the frame body 80 via the lower frame member 84. The at least one fan 42 is coupled to the base of the lower frame member 84. In example embodiments, the fan 42 is an electrically powered active cooling fan. In alternative example embodiments an optional liquid collection pan 49 can be integrated into the heat pump 41 to prevent leaking liquid or condensate from reaching the sensitive surveillance equipment. The liquid collection pan 49 can be mounted between the lower frame member 84 and fan 42, as shown in FIGS. 1 & 2. When implemented, the optional liquid collection pan 49 can also include a drain for diverting collected liquid away from the housing 20. To secure the heat pump components together, the upper frame member 82 and lower frame member 84 can be secured to the frame body 80 with screws, clips, hooks, epoxy, glue, nails, or any other conventional or non-conventional fasteners.

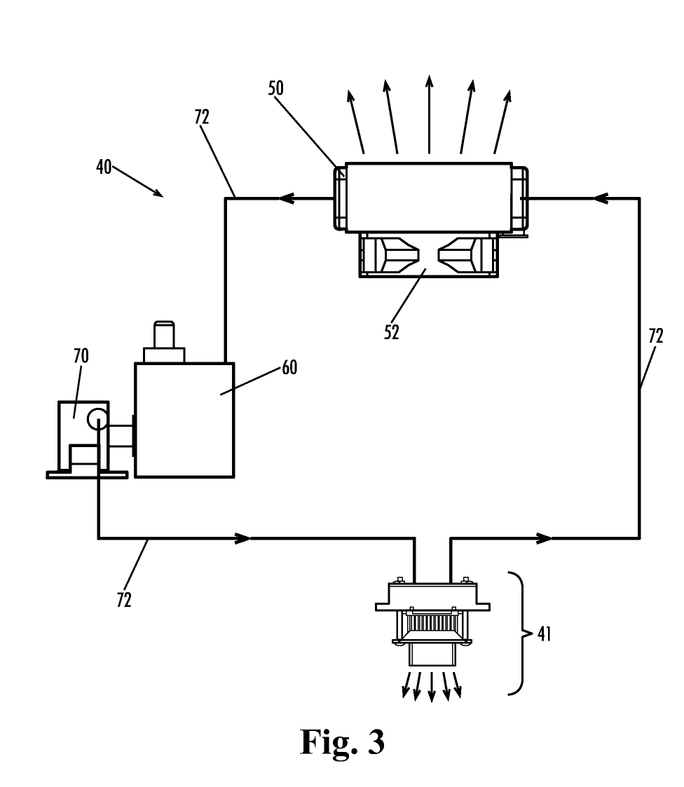

Generally, the cooling system 40 removes heat from the surveillance system housing 20 by extracting heat from inside the housing and ejecting the heat to an external environment, as shown in FIG. 3. In example embodiments, air is cooled within the housing via the heat pump 41. The air within the housing can be atmospheric air, nitrogen, helium and/or other inert gases. Cool air is generated by the heat pump 41 by first applying a voltage to the Peltier device 46. As voltage is applied to the device 46 a temperature differential is created within the same, resulting in a cold side 45 and warm side 47 of the device. As the voltage that is applied to the device increases, the temperature differential between the cold side 45 and warm side 47 increases (the inverse is also true). Heat accumulates on the warm side 47 of the device by removing heat from the cold side 45 of the device, along with heat that is stored within the heat sink 44. As heat is transferred from both the cold side 45 of the Peltier device 46 and the heat sink 44 to the warm side 47, the temperature of the air surrounding both the cold side and heat sink is convectively lowered as heat within the air is absorbed into the cold side 45 and heat sink 44. This heat is then transferred to the warm side 47. The resulting cool air is then circulated through the housing 20 by the fan 42 to lower the air temperature therein. The temperature within the housing 20 can be controlled by adjusting the speed of the fan 42 and/or by regulating the amount of heat that is extracted by the Peltier device 46 (i.e. by regulating the voltage that is applied to the Peltier device and/or by regulating the amount of heat that is removed from the warm side 47).

The heat that collects on the warm side 47 of the Peltier device 46 is removed from the device through absorption (convection and/or conduction) into the liquid block 48. A cooling liquid that is circulated via the liquid tubes 72 enters the liquid block 48, absorbs this heat, and carries it away from the heat pump 41. The liquid used in conjunction with the present invention can be water, R-134a, R-12, R-22, or any other known liquid coolant. The liquid is circulated throughout the cooling system 40 by the liquid pump 70. After leaving the liquid block 48, the warmed liquid is then pumped through the heat exchanger 50, which ejects heat from the cooling system 40 into the surrounding environment. In preferred embodiments, the heat exchanger 50 is a fan assisted radiator and includes at least one cooling fan 52 to remove the excess heat via forced convection from the warmed liquid. Alternatively, the heat exchanger 50 can be any known conventional heat exchanger or radiator. Once the liquid has been cooled by the radiator 50, the cooled liquid then travels to the holding reservoir 60 before being pumped through the cooling system 40 once again.

The cooling system 40 can be automatically operated by one or more sensors within the surveillance system 10, such that the cooling system intermittently operates as needed to maintain an acceptable range of temperatures within the housing 20. For example, the cooling system can activate when a sensor or thermostat determines that the temperature within the housing has climbed to, or near, a temperature that has been predetermined to be unacceptable. Similarly, the cooling system can deactivate when the temperature within the housing reaches a predetermined acceptable temperature. A user may be able to manually adjust the acceptable range of temperatures depending on the type of surveillance device that is used in conjunction with a particular embodiment. In alternative embodiments, the cooling system 40 can operate continuously, intermittently, on a timed basis, or sporadically as desired by a particular user.

While the invention has been described with reference to preferred and example embodiments, it will be understood by those skilled in the art that a variety of modifications, additions and deletions are within the scope of the invention, as defined by the following claims.

What is claimed is:

1. A climate controlled surveillance system comprising:
a housing for enclosing at least one surveillance device; and
a heat extraction system for removing heat from the housing, the heat extraction system including a Peltier device and a liquid coolant; wherein heat is extracted from the housing by the Peltier device and transferred to the liquid coolant.

2. The climate controlled surveillance system of claim 1, wherein the surveillance system further comprises a liquid pump for circulating the liquid coolant through the heat extraction system.

3. The climate controlled surveillance system of claim 2, wherein the liquid coolant is circulated through a heat exchanger to eject heat into an environment external to the surveillance system.

4. The climate controlled surveillance system of claim 3, wherein the heat exchanger is a fan assisted radiator.

5. The climate controlled surveillance system of claim 1, wherein a heat sink is coupled to the Peltier device to aid the Peltier device in extracting heat from the housing.

6. The climate controlled surveillance system of claim 5, wherein a cooling fan is coupled to the heat sink for circulating cool air within the housing.

7. The climate controlled surveillance system of claim 1, wherein the at least one surveillance device is selected from the group consisting of a video camera, a still camera, illuminator, and/or a listening device.

8. The climate controlled surveillance system of claim 1, further comprising a liquid collection pan to collect leaking liquid coolant or condensation.

9. The climate controlled surveillance system of claim 1, wherein the heat extraction system is selectively operable.

10. The climate controlled surveillance system of claim 9, wherein the heat extraction system is automatically operated by a thermostat to regulate an ambient air temperature within the housing.

11. A cooling apparatus for a surveillance system comprising:
a Peltier driven heat pump;
a heat exchanger;
a liquid reservoir; and
at least one liquid pump for pumping a liquid coolant through one or more tubes, the tubes in connection with the heat pump, heat exchanger, and liquid reservoir.

12. The cooling apparatus of claim 11, wherein the heat pump comprises at least one fan, a heat sink, a Peltier device, and a liquid cooling block.

13. The cooling apparatus of claim 12, further comprising a rigid frame.

14. The cooling apparatus of claim 13, wherein the rigid frame includes an upper frame member and a lower frame member that encapsulates a frame body.

15. The cooling apparatus of claim 14, wherein the upper frame member, lower frame member and frame body are formed from rubber, aluminum, steel, metal alloys, polymers, and/or wood.

16. The cooling apparatus of claim 12, further comprising a water collection pan.

17. The cooling apparatus of claim 11 wherein the heat exchanger is a fan assisted radiator.

18. A surveillance system having a housing and at least one surveillance device at least partially contained therein, wherein the improvement comprises:
a cooling system for removing heat from the housing, the cooling system including a Peltier device in communication with a liquid coolant and at least one fan, the at least one fan substantially contained within the housing for circulating air therein.

19. The improvement of claim 18, wherein the cooling system further comprises a liquid pump for circulating the liquid coolant within the surveillance device.

20. The improvement of claim 19, wherein the cooling system further comprises a heat exchanger in communication with the liquid coolant for dissipating heat to the environment.
